(19) United States
(12) Patent Application Publication
(10) Pub. No.: US 2019/0236783 A1
(43) Pub. Date: Aug. 1, 2019

(54) IMAGE PROCESSING APPARATUS, IMAGE PROCESSING METHOD, AND PROGRAM

(71) Applicant: FUJIFILM Corporation, Tokyo (JP)

(72) Inventor: Akimichi ICHINOSE, Tokyo (JP)

(73) Assignee: FUJIFILM Corporation, Tokyo (JP)

(21) Appl. No.: 16/248,087

(22) Filed: Jan. 15, 2019

(30) Foreign Application Priority Data
Jan. 26, 2018 (JP) 2018-011753

(51) Int. Cl. G06T 7/00; G06T 7/33; G06T 7/11; G06T 5/50

(52) U.S. Cl. CPC G06T 7/0016; G06T 7/337; G06T 7/11; G06T 5/50; G06T 2207/10028; G06T 2207/20081; G06T 2207/20212; G06T 2207/10081; G06T 2207/30061

(57) ABSTRACT

Provided are an image processing apparatus, an image processing method, and a program that can register a plurality of medical images with high accuracy.

The image processing apparatus includes: an image acquisition unit that acquires a first medical image and a second medical image; an extraction unit that extracts a plurality of regions including a region of interest from each of the first medical image and the second medical image; a landmark region selection unit that selects a specific region which is a region common to the first medical image and the second medical image and is different from the region of interest as a landmark region; and a registration unit that performs rigid registration or linear registration, using the landmark region as a standard for registration, to generate a resultant image in which the first medical image and the second medical image have been superimposed.

### CROSS-REFERENCE TO RELATED APPLICATIONS

The present application claims priority under 35 U.S.C. § 119 to Japanese Patent Application No. 2018-011753, filed on Jan. 26, 2018. The above application is hereby expressly incorporated by reference, in its entirety, into the present application.

### BACKGROUND OF THE INVENTION

### 1. Field of the Invention

The present invention relates to an image processing apparatus, an image processing method, and a program and more particularly, to the registration of medical images.

### 2. Description of the Related Art

In the field of medical image diagnosis, analysis, such as the comparison between feature regions common to a plurality of medical images, is performed. An example of the plurality of medical images is a plurality of medical images of the same subject which are captured by the same modality at different imaging times.

JP2016-016205A discloses a medical image measurement apparatus that performs non-rigid registration between an image of a lesion region included in a first medical image captured in the past and an image of a lesion region included in a second medical image captured most recently. The medical image measurement apparatus disclosed in JP2016-016205A acquires a third measurement parameter using an image variation obtained as the result of non-rigid registration.

In a case in which analysis, such as the comparison between a plurality of medical images, is performed, it is important to register the plurality of medical images with high accuracy. In a case in which a plurality of medical images are registered, a landmark which is a standard for registration is used.

JP2017-063936A discloses an image registration apparatus that registers two images of a subject formed by a plurality of bones which have been captured at different times. The image registration apparatus disclosed in JP2017-063936A sets at least three landmarks for each bone part and performs a registration process using the at least three landmarks.

JP2016-104121A discloses a medical image processing apparatus that performs rigid registration for a rigid region between first medical image data and second medical image data and performs non-rigid registration for a non-rigid region.

JP2017-164075A discloses an image registration apparatus that registers an intraoperative image including an operation target part and a related image related to an operation on a target part. The image registration apparatus disclosed in JP2017-164075A extracts a plurality of corresponding feature points from the intraoperative image registered with the related image and a newly acquired intraoperative image.

The image registration apparatus disclosed in JP2017-164075A acquires positional information indicating a relative difference between the intraoperative image registered with the related image and the newly acquired intraoperative image on the basis of a plurality of feature points to which priorities have been set and registers the related image and the newly acquired intraoperative image on the basis of the positional information. A higher priority is given to a pixel located at a position more suitable for registration.

JP4750429B discloses a method that presets a plurality of feature parts which will be landmarks in the body in a case in which an MRI image in the same tomographic plane as an ultrasound image is acquired and relatively determines an imaging surface in a subject on the basis of the feature parts. In JP4750429B, a skeleton that is less influenced by respiration and peristalsis and the outline of the organs can be used as the feature parts. In addition, MRI is an abbreviation of magnetic resonance imaging.

### SUMMARY OF THE INVENTION

However, JP2016-016205A does not disclose the registration of a first medical image and a second medical image.

In the technique disclosed in JP2017-063936A, in a case in which a vertebral region is registered between a three-dimensional image captured in the past and a three-dimensional image captured at the present time, a landmark is set in the vertebral region. In a case in which the landmark is included in a registration target region, a change in inclination occurs between a plurality of medical images to be registered due to a difference in, for example, the posture of a subject. In this case, it is difficult to accurately perform registration.

JP2016-104121A and JP2017-164075A do not disclose a landmark region which is a standard for registering a plurality of medical images. The technique disclosed in JP2016-104121A and the technique disclosed in JP2017-164075A do not disclose the registration of a plurality of medical images using the landmark region.

The technique disclosed in JP4750429B deforms an image captured by an imaging apparatus other than an ultrasound imaging apparatus on the basis of the evaluation result of an ultrasound image and displays the deformed image as a two-dimensional image or a three-dimensional image. However, the technique does not register a plurality of medical images.

In addition, the landmark in the technique disclosed in JP4750429B is used to relatively determine the imaging surface in the subject and is not a standard for registering a plurality of medical images.

The present invention has been made in view of the above-mentioned problems and an object of the invention is to provide an image processing apparatus, an image processing method, and a program that can register a plurality of medical images with high accuracy.

In order to achieve the object, the invention provides the following aspects.

According to a first aspect, there is provided an image processing apparatus comprising: an image acquisition unit that acquires a plurality of medical images including a first medical image and a second medical image each of which includes a region of interest to be compared; an extraction unit that extracts a plurality of regions including the region of interest from each of the first medical image and the second medical image; a landmark region selection unit that selects a specific region which is common to the first medical image and the second medical image and is different from the region of interest among the plurality of regions of the first medical image and the plurality of regions of the second medical image as a landmark region which is a standard for registering the first medical image and the second medical image; and a registration unit that performs rigid registration or linear registration for the first medical image and the second medical image, using the landmark region as the registration standard, to generate a resultant image in which the first medical image and the second medical image have been superimposed.

According to the first aspect, the specific region different from the region of interest is selected as the landmark region. Rigid registration or linear registration is performed for the first medical image and the second medical image on the basis of the landmark region. Therefore, it is possible to register the first medical image and the second medical image with high accuracy.

The region of interest is included in the first medical image and the second medical image and is, for example, a region to be subjected to analysis, such as observation and measurement, in the first medical image and the second medical image. Examples of the region of interest include an organ and a tissue. Examples of the tissue include a bone, a joint, a tendon, muscle, a tumor, and a lump.

An example of the medical image is a digital medical image of a subject captured by a modality. A two-dimensional image or a three-dimensional image may be applied as the medical image.

The landmark region selection unit may select one landmark region or may select a plurality of landmark regions.

The image processing apparatus according to the first aspect comprises one or more processors and one or more memories. The processor acquires the first medical image and the second medical image each of which includes the region of interest to be compared, extracts a plurality of regions including the region of interest from each of the first medical image and the second medical image, selects a specific region which is common to the first medical image and the second medical image and is different from the region of interest among the plurality of regions of the first medical image and the plurality of regions of the second medical image as the landmark region which is a standard for registering the first medical image and the second medical image, and performs rigid registration or linear registration for the first medical image and the second medical image, using the landmark region as the registration standard, to generate the resultant image in which the first medical image and the second medical image have been superimposed. The memory stores data in each process.

According to a second aspect, the image processing apparatus according to the first aspect may further comprise a region-of-interest selection unit that selects one or more regions of interest from the plurality of regions of the first medical image and the plurality of regions of the second medical image.

According to the second aspect, it is possible to randomly select one or more regions of interest from the regions extracted from the first medical image and the second medical image.

According to a third aspect, in the image processing apparatus according to the second aspect, the registration unit may generate a resultant image in which the regions of interest selected by the region-of-interest selection unit have been superimposed.

According to the third aspect, it is possible to perform analysis such as the comparison between the first medical image and the second medical image.

In the resultant image, the region of interest may be displayed or regions other than the region of interest may not be displayed.

According to a fourth aspect, in the image processing apparatus according to any one of the first to third aspects, the extraction unit may extract the regions on the basis of a result of learning using a set of the medical images and an extraction result of the regions or a set of the medical images and a selection result of the landmark region as correct answer data.

According to the fourth aspect, it is possible to perform high-accuracy region extraction in which the result of learning using the correct answer data has been reflected.

According to a fifth aspect, in the image processing apparatus according to any one of the first to fourth aspects, the extraction unit may extract the regions on the basis of a result of learning for each region using a set of the medical images and an extraction result of each of the regions or a set of the medical images and a selection result of the landmark region as correct answer data.

According to the fifth aspect, it is possible to perform high-accuracy region extraction in which the result of learning using the individual correct answer data for each region has been reflected.

According to a sixth aspect, the image processing apparatus according to any one of the first to fifth aspects may further comprise a landmark candidate region setting unit that sets landmark candidate regions, which are candidates of the landmark region, in the first medical image and the second medical image.

According to the sixth aspect, it is possible to set the landmark candidate regions applied to the first medical image and the second medical image.

In the sixth aspect, the image processing apparatus may further comprise an input device that inputs landmark candidate region setting information.

According to a seventh aspect, in the image processing apparatus according to the sixth aspect, the landmark candidate region setting unit may set all of regions which are capable of becoming the landmark region among the regions forming at least one of the first medical image or the second medical image as the landmark candidate regions.

According to the seventh aspect, it is possible to set all of the regions which can be the landmark region as the landmark candidate regions.

According to an eighth aspect, in the image processing apparatus according to the sixth or seventh aspect, the landmark region selection unit may select the landmark region from the regions extracted from the first medical image and the second medical image among the landmark candidate regions.

According to the eighth aspect, it is possible to select the landmark region from the landmark candidate regions.

In the eighth aspect, the image processing apparatus may further comprise an input device that inputs landmark region selection information.

According to a ninth aspect, the image processing apparatus according to any one of the sixth to eighth aspects may further comprise a priority setting unit that sets priorities to the landmark candidate regions.

According to the ninth aspect, it is possible to set the landmark region on the basis of the priorities set to the landmark candidate regions.

According to a tenth aspect, in the image processing apparatus according to the ninth aspect, in a case in which two or more landmark candidate regions are set, the landmark region selection unit may select one or more landmark regions in descending order of the priorities of the landmark candidate regions.

According to the tenth aspect, it is possible to set the landmark regions in descending order of the priorities of the landmark candidate regions.

In the tenth aspect, the image processing apparatus may further comprise an input device that inputs priority setting information.

According to an eleventh aspect, in the image processing apparatus according to any one of the first to tenth aspects, the landmark region selection unit may select a plurality of the landmark regions. In a case in which the resultant image is generated using the plurality of landmark regions selected by the landmark region selection unit, the registration unit may register the first medical image and the second medical image such that an error between the landmark regions is minimized.

According to the eleventh aspect, it is possible to register the first medical image and the second medical image using a plurality of landmarks with high accuracy.

According to a twelfth aspect, in the image processing apparatus according to any one of the first to eleventh aspects, the image acquisition unit may acquire the first medical image and the second medical image generated by the same type of modality.

According to the twelfth aspect, it is possible to generate a resultant image in which the first medical image and the second medical image generated by the same type of modality have been registered.

According to a thirteenth aspect, in the image processing apparatus according to any one of the first to twelfth aspects, medical images of the same examination part of the same patient which have been generated at different times may be applied as the first medical image and the second medical image.

According to the thirteenth aspect, it is possible to analyze, for example, a change in the same examination part of the same patient over time.

According to a fourteenth aspect, the image processing apparatus according to any one of the first to thirteenth aspects may further comprise an image signal transmission unit that transmits a resultant image signal indicating the resultant image to a display device.

According to the fourteenth aspect, it is possible to display the resultant image using the display device.

According to a fifteenth aspect, the image processing apparatus according to any one of the first to fourteenth aspects may further comprise a display selection unit that selects whether to display the entire resultant image on the display device or to display only the region of interest of the resultant image on the display device.

According to the fifteenth aspect, it is possible to select whether to display the entire resultant image or to display only the region of interest of the resultant image.

According to a sixteenth aspect, there is provided an image processing method comprising: an image acquisition step of acquiring a plurality of medical images including a first medical image and a second medical image each of which includes a region of interest to be compared; an extraction step of extracting a plurality of regions including the region of interest from each of the first medical image and the second medical image; a landmark region selection step of selecting a specific region which is common to the first medical image and the second medical image and is different from the region of interest among the plurality of regions of the first medical image and the plurality of regions of the second medical image as a landmark region which is a standard for registering the first medical image and the second medical image; and a registration step of performing rigid registration or linear registration for the first medical image and the second medical image, using the landmark region as the registration standard, to generate a resultant image in which the first medical image and the second medical image have been superimposed.

According to the sixteenth aspect, it is possible to obtain the same effect as that in the first aspect.

In the sixteenth aspect, the same matters as those specified in the second to fifteenth aspects can be appropriately combined with each other. In this case, the components that are in charge of the processes or functions specified in the image processing apparatus can be understood as components of the image processing method which are in charge of processes or functions corresponding to the processes or functions.

According to a seventeenth aspect, there is provided a program that causes a computer to implement: an image acquisition function of acquiring a plurality of medical images including a first medical image and a second medical image each of which includes a region of interest to be compared; an extraction function of extracting a plurality of regions including the region of interest from each of the first medical image and the second medical image; a landmark region selection function of selecting a specific region which is common to the first medical image and the second medical image and is different from the region of interest among the plurality of regions of the first medical image and the plurality of regions of the second medical image as a landmark region which is a standard for registering the first medical image and the second medical image; and a registration function of performing rigid registration or linear registration for the first medical image and the second medical image, using the landmark region as the registration standard, to generate a resultant image in which the first medical image and the second medical image have been superimposed.

According to the seventeenth aspect, it is possible to obtain the same effect as that in the first aspect.

In the seventeenth aspect, the same matters as those specified in the second to fifteenth aspects can be appropriately combined with each other. In this case, the components that are in charge of the processes or functions specified in the image processing apparatus can be understood as components of the program which are in charge of processes or functions corresponding to the processes or functions.

According to the invention, a specific region different from the region of interest is selected as the landmark region. Rigid registration or linear registration is performed for the first medical image and the second medical image on the basis of the landmark region. Therefore, it is possible to register the first medical image and the second medical image with high accuracy.

### BRIEF DESCRIPTION OF THE DRAWINGS

FIG. 1 is a block diagram illustrating an example of the configuration of a medical information system according to an embodiment.

FIG. 2 is a block diagram illustrating an example of the hardware configuration of an image processing apparatus.

FIG. 3 is a functional block diagram illustrating the functions of the image processing apparatus.

FIG. 4 is a functional block diagram illustrating the functions of an image processing unit according to a first embodiment.

FIG. 5 is a flowchart illustrating the flow of the procedure of an image processing method according to the first embodiment.

FIG. 6 is a diagram schematically illustrating an example of the registration of chest X-ray images.

FIG. 7 is a diagram schematically illustrating another example of the registration of the chest X-ray images.

FIG. 8 is a diagram illustrating an example of the configuration of a display selection screen.

FIG. 9 is a diagram schematically illustrating another example of the registration of head CT images.

FIG. 10 is a diagram schematically illustrating another example of the registration of the head CT images and is a diagram schematically illustrating an example of the selection of the skull and the eyeball as landmark regions.

FIG. 11 is a diagram schematically illustrating another example of the registration of the head CT images and is a diagram schematically illustrating an example of the selection of the skull and the cheekbone as the landmark regions.

FIG. 12 is a diagram illustrating an example of the configuration of a processing target image selection screen.

FIG. 13 is a block diagram illustrating the functions of an image processing unit according to a second embodiment.

FIG. 14 is a diagram illustrating an example of the configuration of a priority setting screen.

FIG. 15 is a flowchart illustrating the flow of the procedure of an image processing method according to the second embodiment.

FIG. 16 is a block diagram illustrating an example of the configuration of an information processing system to which a network system is applied.

### DESCRIPTION OF THE PREFERRED EMBODIMENTS

Hereinafter, preferred embodiments of the invention will be described in detail with reference to the accompanying drawings. In the specification, the same components are denoted by the same reference numerals and the description thereof will not be repeated.

Overall Configuration of Medical Information System

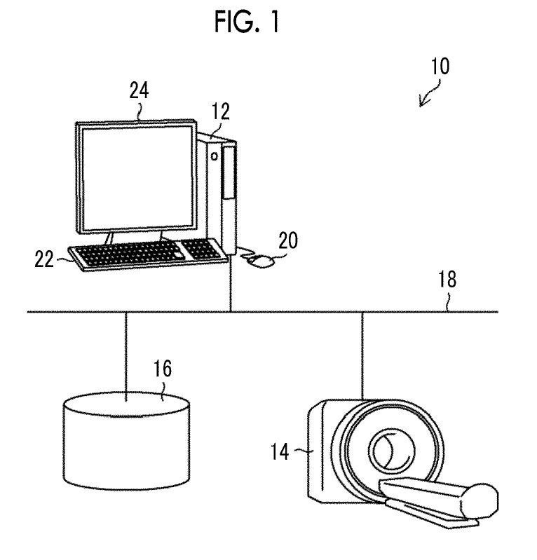

FIG. 1 is a block diagram illustrating an example of the configuration of a medical information system according to an embodiment. A medical information system 10 comprises an image processing apparatus 12, a modality 14, and an image database 16. The image processing apparatus 12, the modality 14, and the image database 16 are connected through a network 18 so as to communicate with each other. An example of the medical information system 10 is a picture archiving and communication system (PACS).

A computer provided in a medical institution can be applied as the image processing apparatus 12. A mouse 20 and a keyboard 22 as an input device are connected to the image processing apparatus 12. In addition, a display device 24 is connected to the image processing apparatus 12.

The modality 14 is an imaging apparatus that captures an image of an examination target part of a subject and generates a medical image. Examples of the modality include an X-ray imaging apparatus, a CT apparatus, an Mill apparatus, a PET apparatus, an ultrasound apparatus, and a CR apparatus using a flat X-ray detector.

CT is an abbreviation of computed tomography. PET apparatus is an abbreviation of positron emission tomography. In some cases, the flat X-ray detector is called a flat panel detector (FPD). CR is an abbreviation of computed radiography.

A DICOM standard can be applied as the format of the medical image. Accessory information defined by the DICOM standard may be added to the medical image. DICOM is an abbreviation of digital imaging and communications in medicine.

A computer comprising a high-capacity storage device can be applied as the image database 16. Software for providing the functions of a database management system is incorporated into the computer. In some cases, the database management system is called a database management system (DBMS).

A local area network (LAN) can be applied as the network 18. A wide area network (WAN) may be applied as the network 18. The DICOM standard can be applied as the communication protocol of the network 18. In addition, the network 18 may be configured so as to be connected to a public line network or may be configured so as to be connected to a leased line network. The network 18 may be a wired network or a wireless network.

Configuration of Image Processing Apparatus

Hardware Configuration

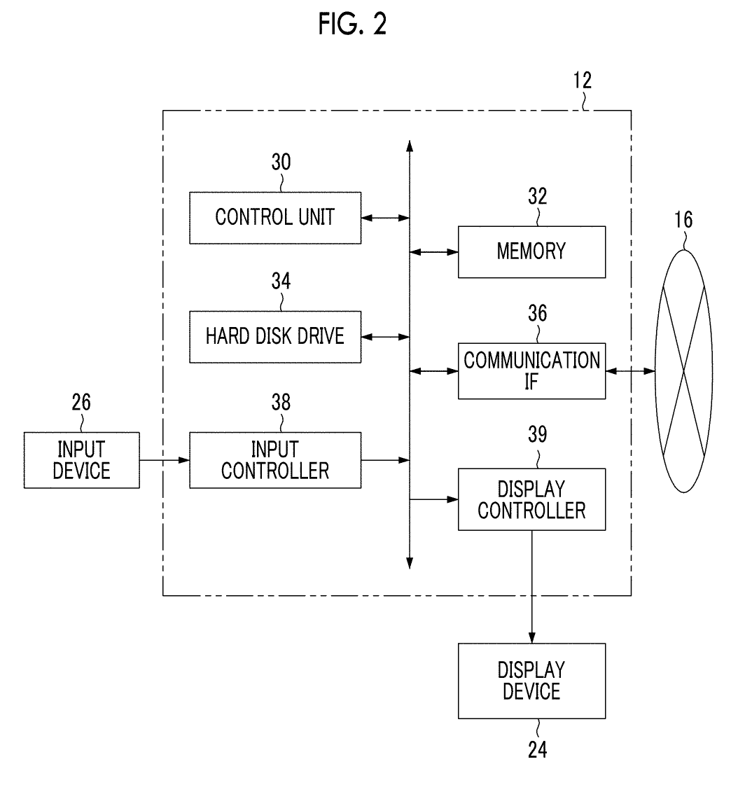

FIG. 2 is a block diagram illustrating an example of the hardware configuration of the image processing apparatus. The image processing apparatus 12 includes a control unit 30, a memory 32, a hard disk drive 34, a communication interface 36, an input controller 38, and a display controller 39.

Control Unit

The control unit 30 functions as an overall control unit for the image processing apparatus 12, various arithmetic units, and a storage control unit. The control unit 30 executes programs stored in a read only memory (ROM) provided in the memory 32. The control unit 30 may download a program from an external storage device through the communication interface 36 and may execute the downloaded program. The external storage device may be connected so as to communicate with the image processing apparatus 12 through the network 18.

The control unit 30 performs various processes in cooperation with various programs, using a random access memory (RAM) provided in the memory 32 as an arithmetic region. In this way, various functions of the image processing apparatus 12 are implemented.

The control unit 30 controls the reading of data from the hard disk drive 34 and the writing of data to the hard disk drive 34. The control unit 30 may include one processor or two or more processors.

Examples of the processor include a field programmable gate array (FPGA) and a programmable logic device (PLD). The circuit configuration of the FPGA and the PLD can be changed after the FPGA and the PLD are manufactured.

Another example of the processor is an application specific integrated circuit (ASIC). The ASIC has a dedicated circuit configuration that is designed in order to perform a specific process.

Two or more processors of the same type can be applied as the control unit 30. For example, two or more FPGAs or two PLDs may be used as the control unit 30. Two or more processors of different types may be applied as the control unit 30. For example, one or more FPGAs and one or more ASICs may be applied as the control unit 30.

In a case in which a plurality of control units are provided, the plurality of control units may be configured by one processor. As an example in which the plurality of control units are configured by one processor, a combination of one or more central processing units (CPUs) and software is used to form one processor and the processor functions as the plurality of control units. A graphics processing unit (GPU) which is a processor specialized in image processing may be applied instead of the CPU or in addition to the CPU. Here, the term “software” is synonymous with a program. A computer, such as a client apparatus or a server apparatus, is a representative example in which the plurality of control units are configured by one processor.

As another example in which the plurality of control units are configured by one processor, a processor that implements all of the functions of a system including the plurality of control units with one IC chip is used. A system-on-chip (SoC) is a representative example of the processor that implements all of the functions of the system including the plurality of control units with one IC chip. In addition, IC is an abbreviation of integrated circuit.

As such, the hardware structure of the control unit 30 is configured by one or more various processors.

Memory

The memory 32 comprises a ROM (not illustrated) and a RAM (not illustrated). The ROM stores various programs executed by the image processing apparatus 12. The ROM stores, for example, files and parameters used to execute various programs. The RAM functions as a temporary data storage area and a work area of the control unit 30.

Hard Disk Drive

The hard disk drive 34 non-temporarily stores various types of data. Specifically, the hard disk drive 34 stores, for example, medical images. The hard disk drive 34 may be attached to the outside of the image processing apparatus 12. A high-capacity semiconductor memory device may be applied instead of or in addition to the hard disk drive 34.

Communication Interface

The communication interface 36 performs data communication with external apparatuses such as the modality 14 and the image database 16 illustrated in FIG. 1. IF illustrated in FIG. 2 is an abbreviation of interface.

Input Controller

The input controller 38 is an interface that receives a signal transmitted from an input device 26 including the mouse 20 and the keyboard 22 and converts the input signal into a signal in a format that is applied to the image processing apparatus 12.

Display Controller

The display controller 39 is an interface that converts a signal indicating the image generated by the image processing apparatus 12 into a video signal displayed by the display device 24. The display controller 39 transmits the video signal indicating the image to the display device 24.

The hardware configuration of the image processing apparatus 12 illustrated in FIG. 2 is illustrative and some components of the hardware configuration can be appropriately added, removed, and changed.

Functions of Image Processing Apparatus

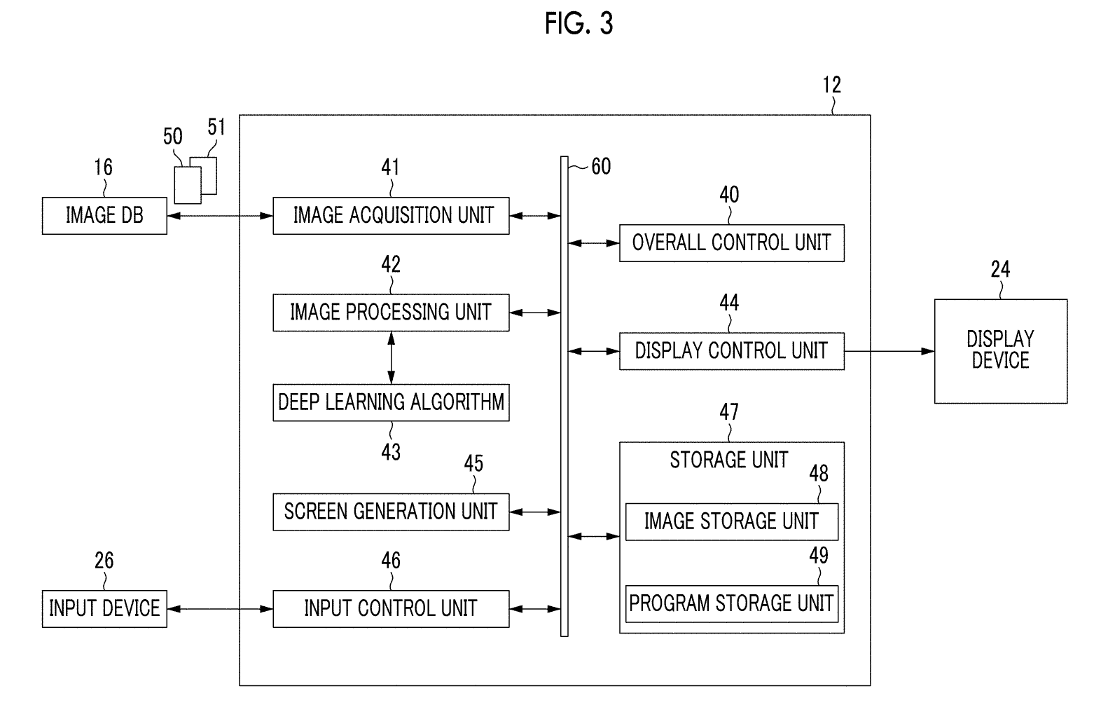

FIG. 3 is a functional block diagram illustrating the functions of the image processing apparatus. The image processing apparatus 12 illustrated in FIG. 3 comprises an overall control unit 40, an image acquisition unit 41, an image processing unit 42, a display control unit 44, a screen generation unit 45, an input control unit 46, and a storage unit 47.

The overall control unit 40, the image acquisition unit 41, the image processing unit 42, the display control unit 44, the screen generation unit 45, the input control unit 46, and the storage unit 47 are connected through a communication signal line 60 so as to communicate with each other. Hereinafter, each unit will be described in detail.

Overall Control Unit

The overall control unit 40 controls the overall operations of the image acquisition unit 41, the image processing unit 42, the display control unit 44, the screen generation unit 45, the input control unit 46, and the storage unit 47 on the basis of the execution of a control program of the image processing apparatus 12.

Image Acquisition Unit

The image acquisition unit 41 acquires the medical image stored in the image database 16 illustrated in FIG. 1. The image database 16 stores the medical image captured by the modality 14. In this embodiment, a chest X-ray image captured by an X-ray imaging apparatus and a head CT image captured by a CT apparatus are given as examples of the medical image.

The image acquisition unit 41 acquires a first medical image 50 and a second medical image 51 including the same region of interest. An example of the first medical image 50 is a medical image of a certain subject and is a medical image captured in the past. An example of the second medical image 51 is a current medical image of the same subject as the first medical image 50.

In addition, a plurality of first medical images 50 may be captured. That is, the image acquisition unit 41 may acquire three or more medical images including the same region of interest. For example, three or more medical images include two or more past images and a current image. In addition, the first medical image 50 and the second medical image 51 may be the past medical images captured at different times.

Image Processing Unit

The image processing unit 42 performs an analysis process for the medical image acquired by the image acquisition unit 41, using deep learning based on a deep learning algorithm 43. The analysis process for the medical image will be described in detail below.

The deep learning algorithm 43 is an algorithm including a known convolutional neural network method, a fully connected layer, and an output layer.

The convolutional neural network is a repeated process of a convolution layer and a pooling layer. In some cases, the convolutional neural network is called a convolution neural network. Since the image analysis process using the deep learning is a known technique, the detailed description thereof will not be repeated. In some cases, the convolutional neural network is represented by CNN. CNN is an abbreviation of convolutional neural network.

Display Control Unit

In a case in which the medical image is played back by the display device 24, the display control unit 44 functions as a display driver that controls the display of images. The display control unit 44 may display the medical image such that various kinds of information are superimposed on the medical image, using the display device 24. The display of the medical image will be described in detail below.

The display control unit 44 displays various screens, such as various selection screens and various setting images, using the display device 24. The display of the various screens will be described in detail below.

Screen Generation Unit

The screen generation unit 45 generates various operation screens to be displayed on the display device 24. The screen generation unit 45 displays various operation screens on the display device 24 through the display control unit 44. Examples of the operation screen include a selection screen for selecting one or more of a plurality of options and a setting screen for setting one or more processing parameters.

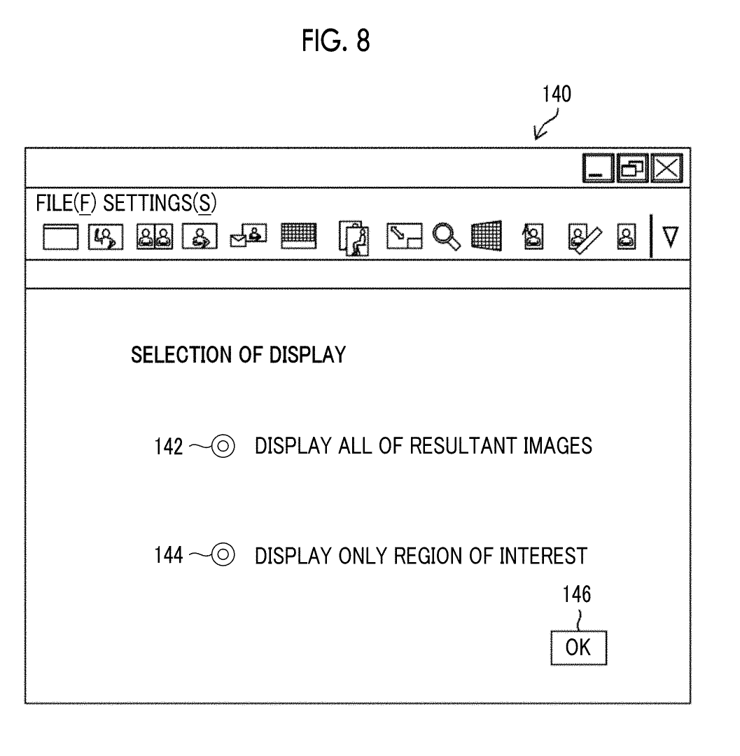

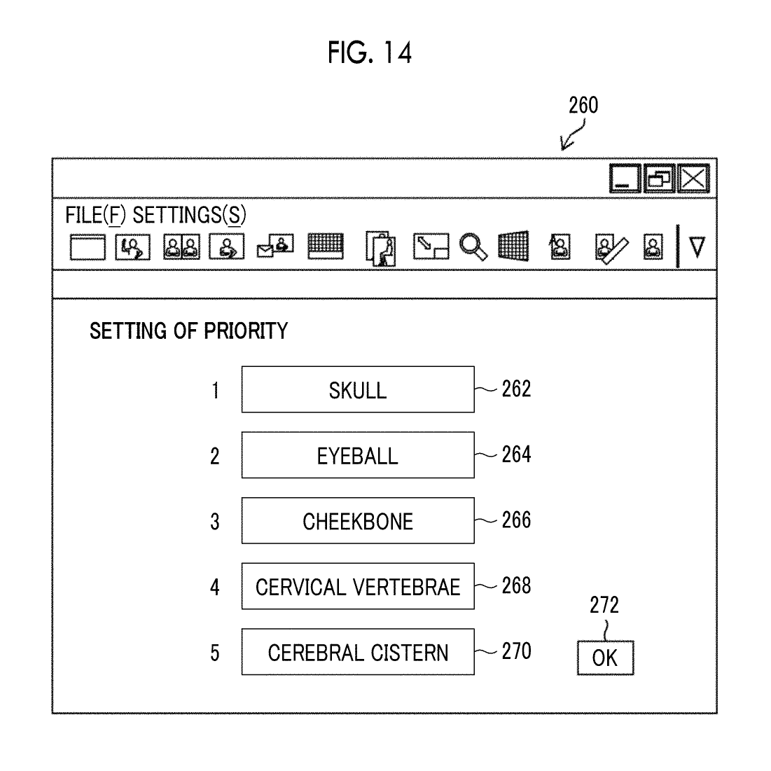

An example of the selection screen is a display selection screen for selecting a display format of a resultant image. In FIG. 8, the display selection screen is represented by reference numeral 140. An example of the setting screen is a priority setting screen for setting the priority of a landmark region. In FIG. 14, the priority setting screen is represented by reference numeral 260.

Input Control Unit

The input control unit 46 converts the signal input from the input device 26 into a signal in a format that is applied to the image processing apparatus 12 and transmits the converted signal to the overall control unit 40. The overall control unit 40 controls each unit of the image processing apparatus 12 on the basis of the information input from the input device 26.

Storage Unit

The storage unit 47 comprises an image storage unit 48 and a program storage unit 49. The image storage unit 48 stores the medical image acquired by the image acquisition unit 41. The image stored in the image storage unit 48 is read to the image processing unit 42 under the control of the overall control unit 40. The image storage unit 48 stores the resultant image which is the processing result of the image processing unit 42.

The program storage unit 49 stores various programs for operating the image processing apparatus 12. The various programs stored in the program storage unit 49 are read to each unit under the control of the overall control unit 40.

Example of Configuration of Image Processing Unit According to First Embodiment

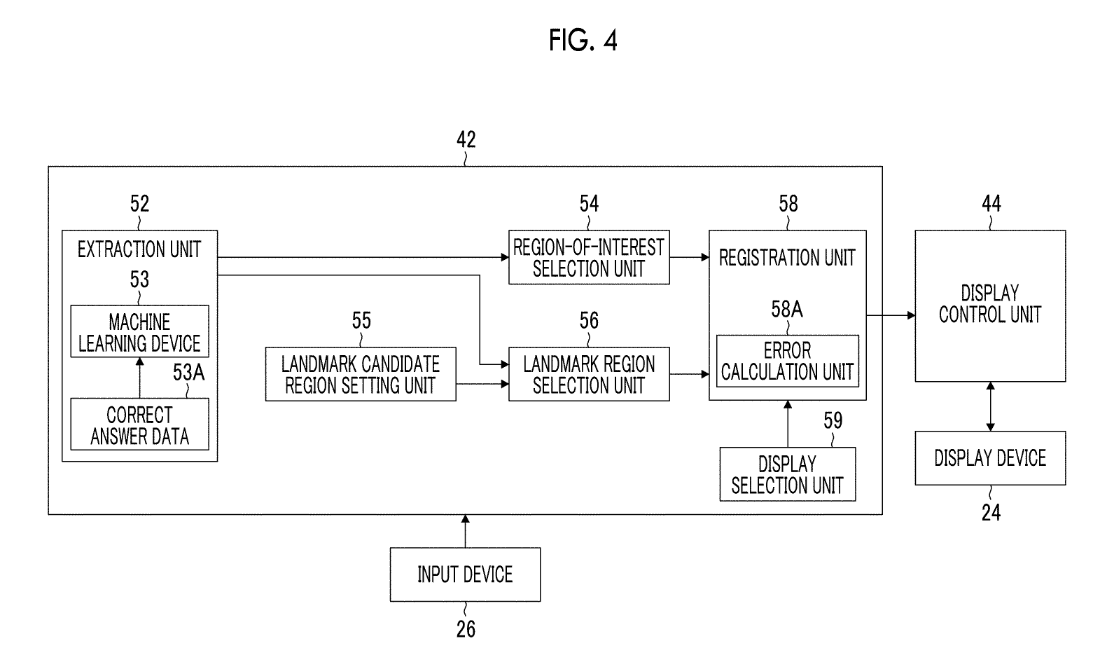

FIG. 4 is a functional block diagram illustrating the functions of the image processing unit according to the first embodiment. The image processing unit 42 comprises an extraction unit 52, a region-of-interest selection unit 54, a landmark candidate region setting unit 55, a landmark region selection unit 56, a registration unit 58, and a display selection unit 59. Hereinafter, each unit forming the image processing unit 42 will be described in detail below.

Extraction Unit

The extraction unit 52 extracts an organ region and a tissue region from each of the first medical image 50 and the second medical image 51 acquired by the image acquisition unit 41 illustrated in FIG. 3. The tissue indicates a concept including the structure of a human body that does not belong to organs, such as a bone, a joint, a tendon, muscle, a tumor, and a lump. The extraction is synonymous with segmentation.

A machine learning device 53 that has learned the feature amount of the organ region and the feature amount of the tissue region is applied to the extraction unit 52. That is, the extraction unit 52 extracts the organ region and the tissue region from the medical image, using an extraction rule based on the learning result of the machine learning device 53. Here, the medical image is a general term of the first medical image 50 and the second medical image 51.

In this embodiment, the machine learning device 53 that performs machine learning using correct answer data 53A including at least one of a correspondence relationship between the medical image and the organ region or a correspondence relationship between the medical image and the tissue region is given as an example. The machine learning device 53 may perform machine learning for each region. For example, in the chest X-ray image, the machine learning device 53 may perform learning for each heart, each clavicle, each organ, and each tissue. The machine learning device 53 may perform learning, using the correspondence relationship between the medical image and the selection result of a landmark region as the correct answer data. The selection of the landmark region will be described below.

Region-of-interest Selection Unit

The region-of-interest selection unit 54 selects one or more regions of interest from the organ region and the tissue region extracted from the first medical image 50 and the second medical image 51 by the extraction unit 52. The region of interest is a registration target region.

For example, in a case in which a heart region of a chest X-ray image is set as the region of interest, the registration between the first medical image 50 and the second medical image 51 makes it possible to perform analysis such as the comparison between a heart region of the first medical image 50 and a heart region of the second medical image 51. Information about the selection of the region of interest by the region-of-interest selection unit 54 is stored in the storage unit 47 illustrated in FIG. 3. The region-of-interest selection unit 54 can set the region of interest on the basis of a signal indicating region-of-interest selection information input through the input device 26.

Landmark Candidate Region Setting Unit

The landmark candidate region setting unit 55 defines a landmark candidate region in advance. The landmark candidate region is stored in a landmark candidate region storage unit (not illustrated). The landmark candidate region storage unit may be provided in the storage unit 47 illustrated in FIG. 3.

The landmark candidate region setting unit 55 can set, as the landmark candidate regions, all of the regions that can be the landmark regions among all of the regions forming the first medical image 50 and the second medical image 51.

The landmark candidate region setting unit 55 may define the landmark candidate region for each subject and for each modality that generates the medical image. That is, the landmark candidate region setting unit 55 may define the landmark candidate region for each type of medical image.

The landmark candidate region is an organ and a tissue that can be used as the landmark region which is a standard for registering a plurality of medical images. The landmark candidate region setting unit 55 can set the landmark candidate region on the basis of a signal indicating the landmark candidate region setting information input through the input device 26.

A region in which a change in anatomical features is within an allowable range can be applied as the landmark candidate region. The allowable range of the change can be appropriately defined according to conditions such as the type of medical image and the type of landmark candidate region. It is preferable that anatomical features do not change in the landmark candidate region. Here, the term “not change” includes a case in which anatomical features change in practice, but there is no substantial change such that the change is negligible. An example of the change in anatomical features is a change in anatomical features over time.

A region whose positional movement is within an allowable range can be applied as the landmark candidate region. The allowable range of the positional movement can be appropriately defined according to conditions such as the type of medical image and the type of landmark candidate region.

Landmark Region Selection Unit

The landmark region selection unit 56 selects, as the landmark region, a region, which has been extracted from the first medical image 50 and the second medical image 51 and is other than the region of interest, from the landmark candidate regions set by the landmark candidate region setting unit 55. The landmark region selection unit 56 may select a plurality of landmark regions. The landmark region selection unit 56 can select the landmark region on the basis of a signal indicating the landmark region selection information input through the input device 26.

Information about the selection of the landmark region by the landmark region selection unit 56 is stored in a landmark region selection information storage unit (not illustrated). The landmark region selection information storage unit may be provided in the storage unit 47 illustrated in FIG. 3.

Registration Unit

The registration unit 58 registers the first medical image 50 and the second medical image 51, using the selection information of the region of interest and the selection information of the landmark region. The registration unit 58 registers the landmark region of the first medical image 50 and the landmark region of the second medical image 51. Rigid registration that performs at least one of parallel movement or rotation is applied as the registration of the first medical image 50 and the second medical image 51. Parallel movement and rotation are performed for at least one of the first medical image 50 or the second medical image 51.

A known method can be applied as the rigid registration. In a case in which the first medical image 50 and the second medical image 51 have an enlargement or reduction relationship therebetween which does not involve deformation, known linear registration, such as affine transformation, can be applied as the registration of the first medical image 50 and the second medical image 51.

The registration unit 58 comprises an error calculation unit 58A that calculates an error between the first medical image and the second medical image. In a case in which a plurality of landmark regions are used, the positions of the landmark regions are unlikely to be matched with each other.

In a case in which a plurality of landmark regions are used, the registration unit 58 registers the first medical image 50 and the second medical image 51 such that the error between the first medical image 50 and the second medical image is minimized. A statistic value of the error of each landmark region can be applied as the error between the first medical image 50 and the second medical image. For example, a sum and an arithmetic mean value can be used as the statistic value.

The registration unit 58 generates a resultant image in which the first medical image 50 and the second medical image 51 have been superimposed. The resultant image is stored in the storage unit 47. The registration unit 58 transmits a resultant image signal indicating the resultant image to the display control unit 44. The registration unit 58 may comprise, as a component, an image signal transmission unit that transmits the resultant image signal to the display control unit 44. The display control unit 44 that has received the resultant image signal indicating the resultant image displays the resultant image using the display device 24.

Display Selection Unit

The display selection unit 59 transmits a selection signal indicating whether to display the entire resultant image or to display only the region of interest of the resultant image to the registration unit 58. The registration unit 58 transmits a resultant image signal indicating the entire resultant image or a resultant image signal indicating only the region of interest of the resultant image to the display control unit 44 on the basis of the selection signal transmitted from the display selection unit 59.

The display control unit 44 displays the entire resultant image or only the region of interest of the resultant image on the basis of the resultant image signal transmitted from the registration unit 58, using the display device 24.

The display selection unit 59 can select the display format of the resultant image on the basis of a signal indicating the display selection information input through the input device 26.

Procedure of Image Processing Method

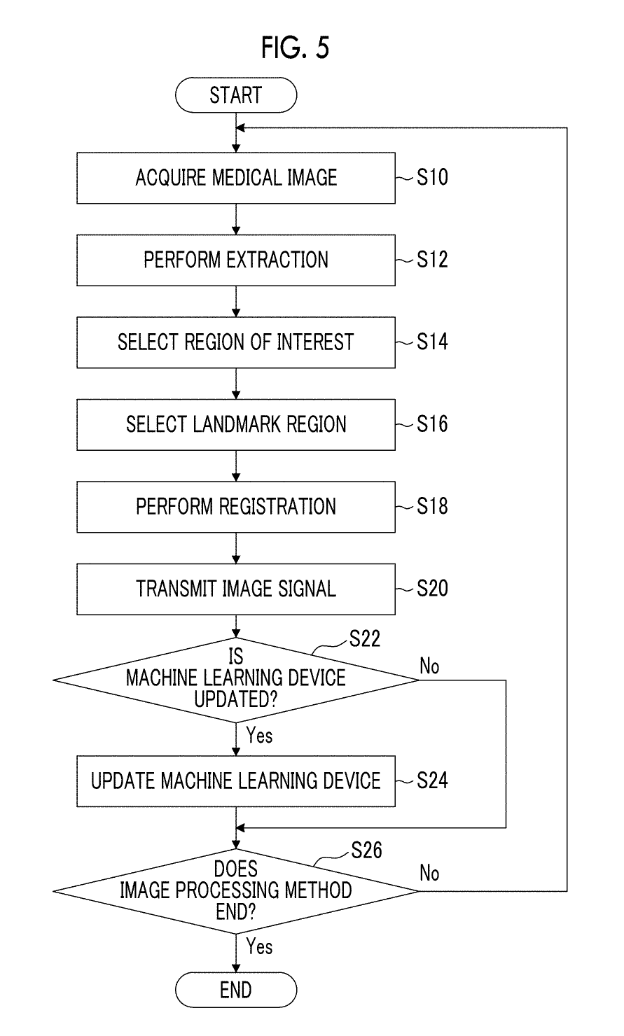

FIG. 5 is a flowchart illustrating the flow of the procedure of an image processing method according to the first embodiment. In a medical image acquisition step S10, the image acquisition unit 41 illustrated in FIG. 3 acquires the first medical image 50 and the second medical image 51. After the medical image acquisition step S10, the process proceeds to an extraction step S12.

In the extraction step S12, the extraction unit 52 illustrated in FIG. 4 extracts regions included in the first medical image 50 and the second medical image 51. After the extraction step S12, the process proceeds to a region-of-interest selection step S14.

In the region-of-interest selection step S14, the region-of-interest selection unit 54 selects the region of interest from the regions extracted in the extraction step S12. After the region-of-interest selection step S14, the process proceeds to a landmark region setting step S16.

In the landmark region selection step S16, the landmark region selection unit 56 selects one or more landmark regions from the regions extracted in the extraction step S12 among the preset landmark candidate regions. After the landmark region selection step S16, the process proceeds to a registration step S18.

After the medical image acquisition step S10, a landmark candidate region setting step of setting the landmark candidate regions from the acquired medical images may be performed. In addition, before the landmark region selection step S16, a landmark candidate region acquisition step of acquiring the preset landmark candidate regions may be performed.

In the registration step S18, the registration unit 58 registers the region of interest of the first medical image 50 and the region of interest of the second medical image 51 on the basis of the landmark region selected in the landmark region selection step S16 to generate a resultant image. After the registration step S18, the process proceeds to an image signal transmission step S20. After the registration step S18, a resultant image storage step of storing the resultant image generated in the registration step S18 may be performed.

In the image signal transmission step S20, the registration unit 58 transmits a resultant image signal indicating the resultant image to the display control unit 44. The display control unit 44 displays the resultant image on the basis of the resultant image signal, using the display device 24. After the image signal transmission step S20, the process proceeds to a machine learning device update determination step S22. After the image signal transmission step S20, a display format selection step of selecting whether to display the entire resultant image or to display only the region of interest of the resultant image may be performed.

In the machine learning device update determination step S22, the machine learning device 53 determines whether to perform machine learning using the extraction result of the extraction unit 52. In a case in which the machine learning is performed in the machine learning device update determination step S22, the determination result is “YES”. In a case in which the determination result is “YES”, the process proceeds to a machine learning device update step S24. On the other hand, in a case in which the machine learning is not performed in the machine learning device update determination step S22, the determination result is “No”. In a case in which the determination result is “No”, the process proceeds to an end determination step S26.

In the machine learning device update step S24, the machine learning device 53 performs machine learning, using a set of the medical image to be extracted by the extraction unit 52 and the extraction result as the correct answer data. The result of the machine learning is applied to the extraction rule of the extraction unit 52. After the machine learning device update step S24, the process proceeds to the end determination step S26.

In the end determination step S26, the image processing unit 42 determines whether to end the image processing method. In a case in which the image processing method is continuously performed in the end determination step S26, the determination result is “No”. In a case in which the determination result is “No”, the process proceeds to the medical image acquisition step S10. On the other hand, in a case in which the image processing method ends in the end determination step S26, the determination result is “Yes”. In a case in which the determination result is “Yes”, the image processing unit 42 ends the image processing method.

FIG. 5 illustrates an example of the image processing method including the machine learning device update determination step S22 and the machine learning device update step S24. The machine learning device update determination step S22 and the machine learning device update step S24 may be performed separately from the steps from the medical image acquisition step S10 to the image signal transmission step S20. That is, in the image processing method according to this embodiment, the machine learning device update determination step S22 and the machine learning device update step S24 can be omitted.

Specific Example of Registration of Medical Images

Next, a specific example of the registration of the medical images by the image processing apparatus and the image processing method will be described. In the following description, the registration of the past medical image and the current medical image of the same person is given as an example. In addition, the past medical image and the current medical image captured by the same type of modality are given as an example.

Example of Registration of Chest X-ray Images

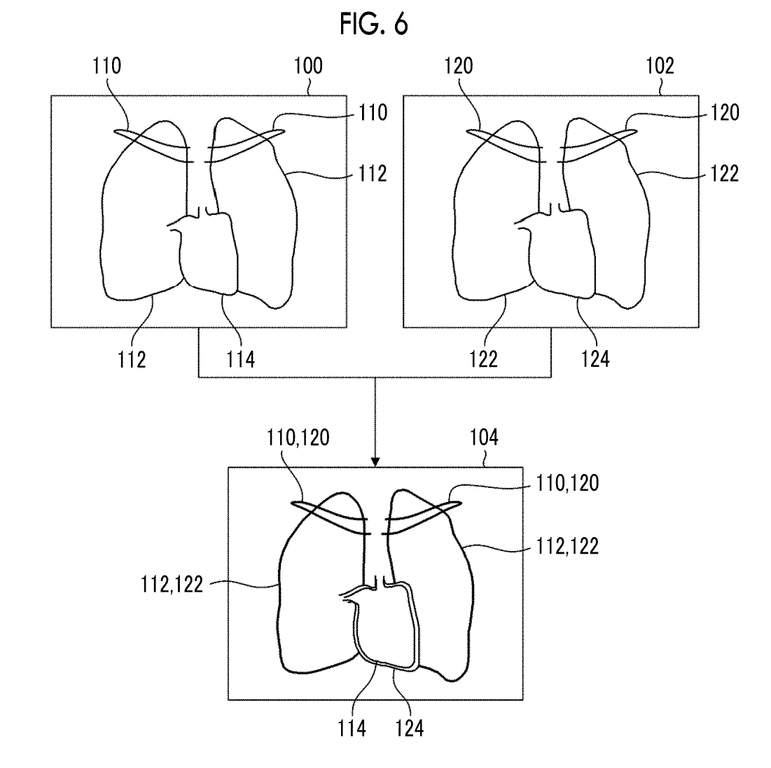

FIG. 6 is a diagram schematically illustrating the registration of chest X-ray images. FIG. 6 illustrates a resultant image 104 generated by performing rigid registration for a past chest X-ray image 100 and a current chest X-ray image 102.

The past chest X-ray image 100 illustrated in FIG. 6 is an example of the first medical image 50 illustrated in FIG. 3. The current chest X-ray image 102 illustrated in FIG. 6 is an example of the second medical image 51 illustrated in FIG. 3.

In the past chest X-ray image 100 and the current chest X-ray image 102, the clavicle, the thorax, the hipbone, the backbone, and the lung field are preset as the landmark candidate regions. Here, the landmark candidate regions of the chest X-ray images are given as an example. Other regions satisfying the conditions of the landmark region may be added and some of the landmark regions may be removed.

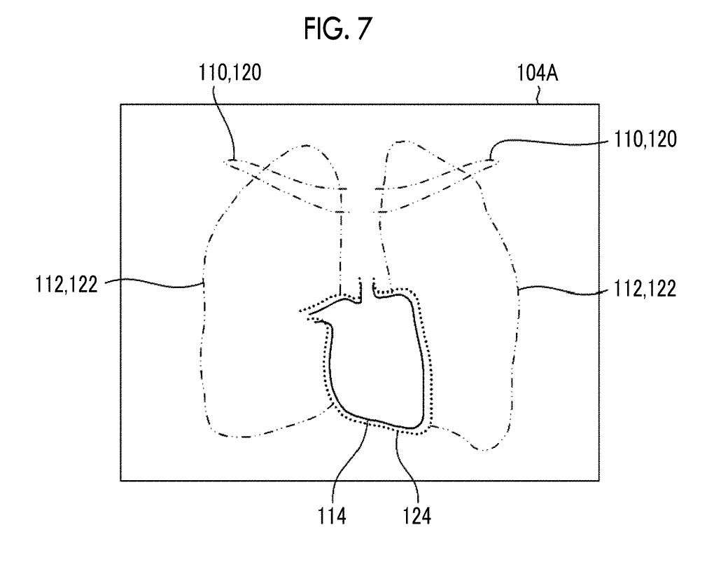

In the past chest X-ray image 100 and the current chest X-ray image 102 illustrated in FIG. 6, the clavicle, the thorax, the backbone, and the lung field except the hipbone are extracted. In addition, in FIG. 6, the backbone and the lung field are not illustrated for convenience of illustration. This holds for FIG. 7.

Reference numeral 110 in the past chest X-ray image 100 and reference numeral 120 in the current chest X-ray image 102 indicate the clavicle. Reference numeral 112 in the past chest X-ray image 100 and reference numeral 122 in the current chest X-ray image 102 indicate the thorax.

The clavicle 110 and the thorax 112 in the past chest X-ray image 100 and the clavicle 120 and the thorax 122 in the current chest X-ray image 102 illustrated in FIG. 6 are selected as the landmark regions. The past chest X-ray image 100 and the current chest X-ray image 102 are registered on the basis of the selected landmark regions.

The heart 114 is selected as the region of interest in the past chest X-ray image 100 illustrated in FIG. 6. In addition, the heart 124 is selected as the region of interest in the current chest X-ray image 102. The resultant image 104 is generated by superimposing the past chest X-ray image 100 and the current chest X-ray image 102. The resultant image 104 makes it possible to perform analysis such as the comparison between the heart 114 in the past chest X-ray image 100 and the heart 124 in the current chest X-ray image 102.

FIG. 6 illustrates a case in which registration is performed using a plurality of landmark regions. In this case, the position of the clavicle 110 in the past chest X-ray image 100 and the position of the clavicle 120 in the current chest X-ray image 102 are unlikely to be matched with each other. In addition, the position of the thorax 112 in the past chest X-ray image 100 and the position of the thorax 122 in the current chest X-ray image 102 are unlikely to be matched with each other.

Therefore, in the image processing according to this embodiment, registration is performed such that the error between the past chest X-ray image 100 and the current chest X-ray image 102 is the minimum. The registration for minimizing the error is as described above and the description thereof will not be repeated.

Another Example of Registration of Chest X-ray Images

FIG. 7 is a diagram schematically illustrating another example of the registration of the chest X-ray images. In a resultant image 104A illustrated in FIG. 7, the registration result of the region of interest is displayed and regions other than the region of interest, such as the landmark region, are not displayed.

In FIG. 7, the heart 114 displayed in the resultant image 104A is represented by a solid line and the heart 124 is represented by a dotted line. In addition, the regions that are not displayed are represented by a two-dot chain line. The regions that are not displayed in the resultant image 104A are the clavicle 110 and the thorax 112 in the past chest X-ray image 100 and the clavicle 120 and the thorax 122 in the current chest X-ray image 102.

FIG. 8 is a diagram illustrating an example of the configuration of a display selection screen. The display selection screen 140 illustrated in FIG. 8 is displayed on the display device 24 illustrated in FIG. 3. An operator operates the input device 26 illustrated in FIG. 3 to select a first selection button 142 or a second selection button 144 displayed on the display selection screen 140 illustrated in FIG. 8 and to press an OK button 146.

The registration unit 58 illustrated in FIG. 4 receives display format selection information. The registration unit 58 transmits a resultant image signal for displaying the entire resultant image 104 to the display control unit 44 or transmits a resultant image signal for displaying only the region of interest to the display control unit 44, according to the display format selection information.

The display device 24 and the input device 26 according to this embodiment function as a graphical user interface (GUI) for selecting the display format of the resultant image 104. In addition, the display device 24 and the input device 26 correspond to an example of components of the display selection unit 59.

Example of Registration of Head CT Images

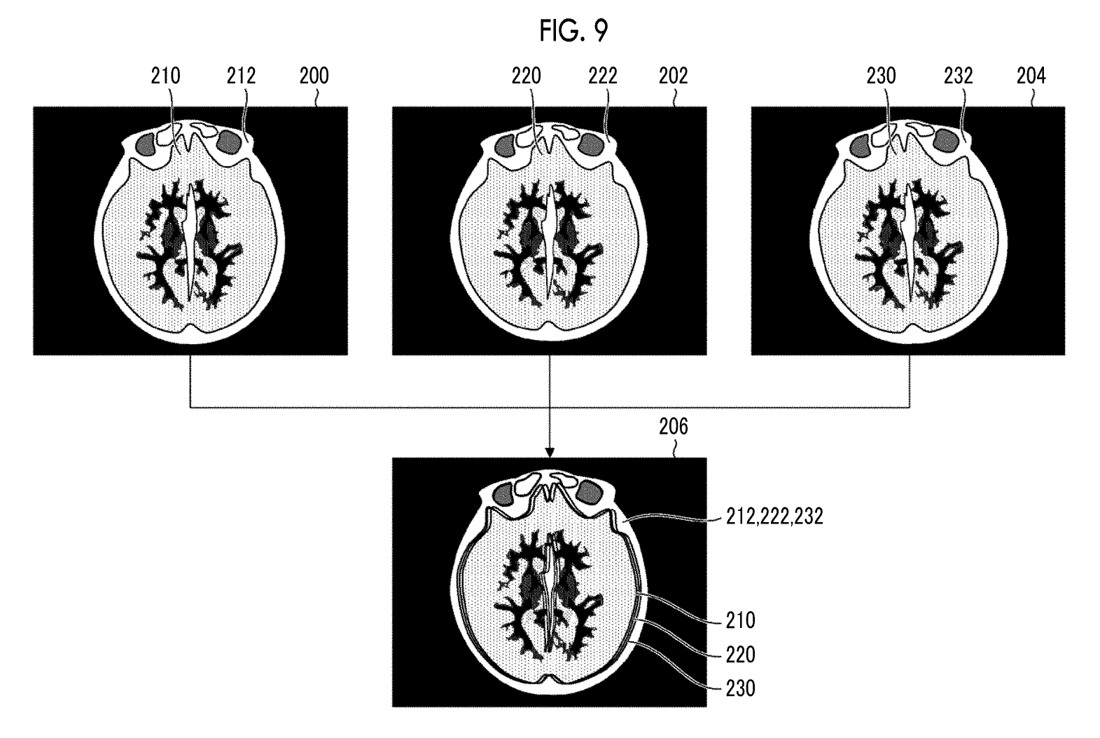

Next, the registration of head CT images will be described as a specific example of the registration of the medical images. FIG. 9 is a diagram schematically illustrating another example of the registration of the head CT images. FIG. 9 illustrates an example in which three medical images, that is, a first past head CT image 200, a second past head CT image 202, and a current head CT image 204 are registered to generate a resultant image 206. The resultant image 206 can be used to perform analysis such as the comparison of a change in the brain selected as the region of interest over time. Reference numeral 210, reference numeral 220, and reference numeral 230 indicate the brain.

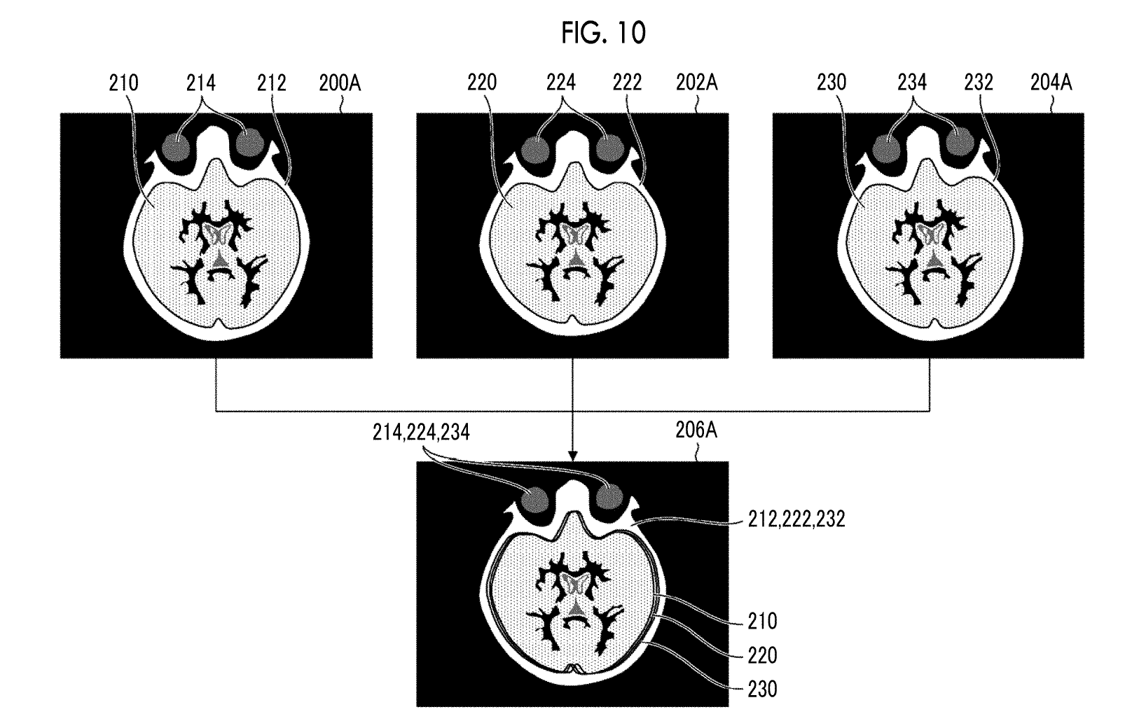

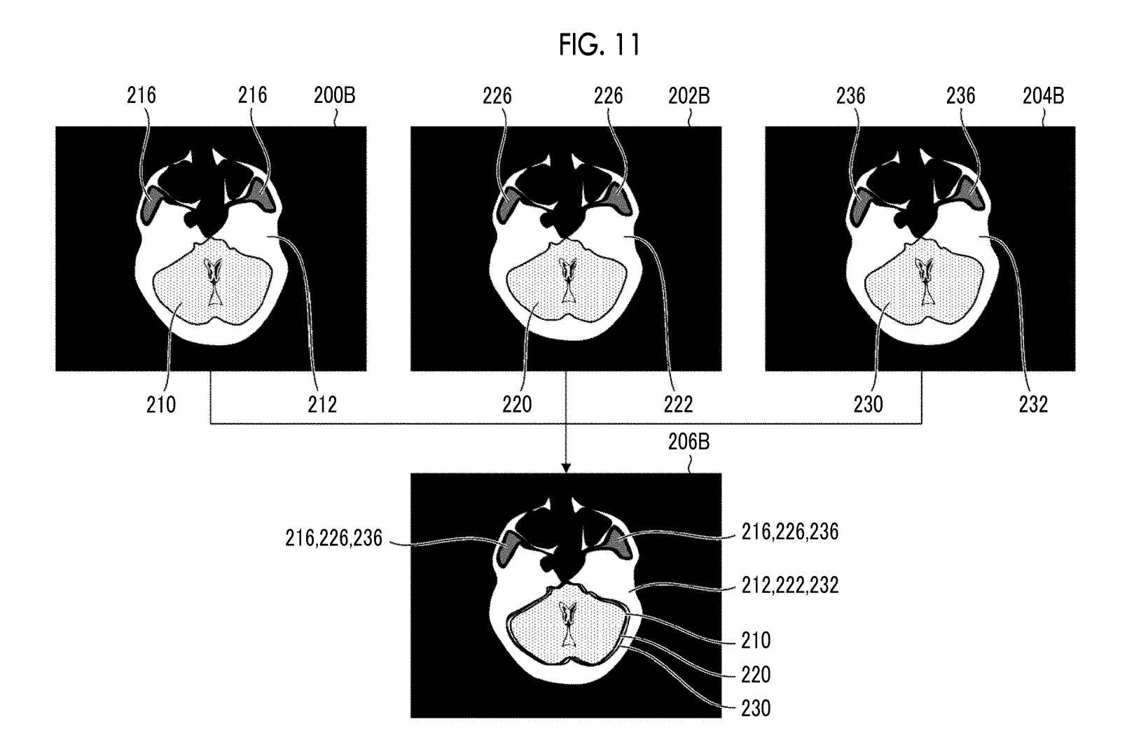

The same slice position is applied to the first past head CT image 200, the second past head CT image 202, and the current head CT image 204 illustrated in FIG. 9. Here, the term “same” is not limited to “exactly same” and may be “substantially same” considered to be “same”. This holds for the head CT images illustrated in FIGS. 10 and 11.

In the registration of the head CT images, the skull, the eyeball, the cheekbone, the cervical vertebrae, and a cerebral cistern region are set as the landmark candidate regions in advance. In addition, the landmark candidate regions of the head CT image described in this embodiment are illustrative and other regions, such as the jawbone, satisfying the conditions of the landmark region may be added. In addition, some of the landmark candidate regions may be removed.

In the first past head CT image 200, the second past head CT image 202, and the current head CT image 204 illustrated in FIG. 9, the skull is extracted among the landmark candidate regions and is selected as the landmark region. Reference numeral 212, reference numeral 222, and reference numeral 232 indicate the skull.

In the example of the registration of the head CT images illustrated in FIG. 9, one landmark candidate region is extracted from the plurality of landmark candidate regions and the extracted landmark candidate region is selected as the landmark region. The head CT images illustrated in FIG. 9 are a general term of the first past head CT image 200, the second past head CT image 202, and the current head CT image 204 illustrated in FIG. 9. This holds for head CT images illustrated in FIG. 10 and head CT images illustrated in FIG. 11.

FIG. 10 is a diagram schematically illustrating another example of the registration of the head CT images. In this example, two landmark candidate regions are extracted from the plurality of landmark candidate regions and the extracted landmark candidate regions are selected as the landmark regions.

That is, the skull and the eyeball are extracted from a first past head CT image 200A, a second past head CT image 202A, and a current head CT image 204A and are selected as the landmark regions. Reference numeral 214, reference numeral 224, and reference numeral 234 illustrated in FIG. 10 indicate the eyeball.

In the first past head CT image 200A illustrated in FIG. 10, the slice position is close to the jaw, as compared to the first past head CT image 200 illustrated in FIG. 9. This holds for the second past head CT image 202A and the current head CT image 204A illustrated in FIG. 10.

The first past head CT image 200A, the second past head CT image 202A, and the current head CT image 204A illustrated in FIG. 10 are registered to generate a resultant image 206A.

FIG. 11 is a diagram schematically illustrating another example of the registration of the head CT images and schematically illustrates an example in which the skull and the cheekbone are selected as the landmark regions. FIG. 11 illustrates an example in which the left and right cheekbones are selected as the landmark regions. However, any one of the left cheekbone and the right cheekbone may be selected as the landmark region. This holds for the clavicle and the thorax illustrated in FIG. 7 and the eyeball illustrated in FIG. 9.

In a first past head CT image 200B illustrated in FIG. 11, the slice position is close to the jaw, as compared to the first past head CT image 200A illustrated in FIG. 10. This holds for a second past head CT image 202B and a current head CT image 204B illustrated in FIG. 11.

Rigid registration is performed for the first past head CT image 200B, the second past head CT image 202B, and the current head CT image 204B illustrated in FIG. 11 to generate a resultant image 206B. Reference numeral 216, reference numeral 226, and reference numeral 236 illustrated in FIG. 11 indicate the eyeball.

In the examples of the registration of the head CT images illustrated in FIGS. 10 and 11, a plurality of landmark regions are selected from a plurality of landmark candidate regions. FIGS. 10 and 11 illustrate the example in which two landmark regions are selected as the plurality of landmark regions. However, three or more landmark regions may be selected.

The display format of the resultant image is the same as that of the chest X image and the entire resultant image may be displayed or only the region of interest may be displayed. The display format of the resultant image can be selected by the same selection screen as the display selection screen 140 illustrated in FIG. 8. In addition, the resultant image is a general term of the resultant image 206 illustrated in FIG. 9, the resultant image 206A illustrated in FIG. 10, and the resultant image 206B illustrated in FIG. 11.

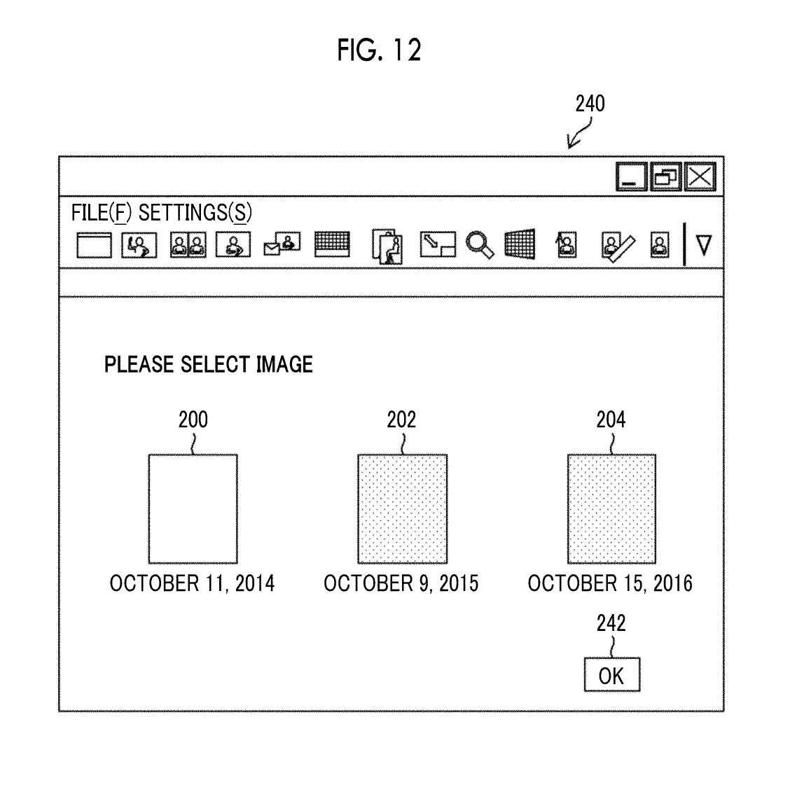

FIG. 12 is a diagram illustrating an example of the configuration of a processing target image selection screen. A processing target image selection screen 240 illustrated in FIG. 12 illustrates a case in which the second past head CT image 202 and the current head CT image 204 are selected as registration processing targets among the first past head CT image 200, the second past head CT image 202, and the current head CT image 204. An OK button 242 is pressed to confirm the selection of the processing target.

That is, in the example illustrated in FIG. 12, the current head CT image 204 and the second past head CT image 202 which is the latest head CT image among the past head CT images are selected as the registration processing targets. In the processing target image selection screen 240 illustrated in FIG. 12, the imaging date is displayed below each of the first past head CT image 200, the second past head CT image 202, and the current head CT image 204. As such, in the processing target image selection screen 240, the accessory information of each medical image may be displayed. In addition, the date illustrated in FIG. 12 is illustrative.

In the processing target image selection screen 240 illustrated in FIG. 12, the first past head CT image 200 and the current head CT image 204 may be selected or the first past head CT image 200, the second past head CT image 202, and the current head CT image 204 may be selected.

In this embodiment, the registration of two-dimensional medical images, such as the chest X-ray images and the head CT images, is described as an example. However, the image processing according to this embodiment can also be applied to three-dimensional medical images.

### Operation and Effect of Image Processing Apparatus and Method According to First Embodiment

The image processing apparatus and method according to the first embodiment can have the following operation and effect.

[1]

A plurality of landmark candidate regions are defined in the medical images to be registered in advance. A plurality of regions including the region of interest are extracted from a plurality of medical images to be registered. One or more landmark regions are selected from the regions which have been extracted from all of the plurality of medical images to be registered and are other than the region of interest among the plurality of landmark candidate regions. The plurality of medical images to be registered are registered using the selected landmark regions as a standard for registration. Therefore, it is possible to register the plurality of medical images to be registered with high accuracy.

[2]

The region of interest is selected from the regions extracted from the plurality of medical images to be registered. Therefore, it is possible to randomly set one or more of the regions extracted from the plurality of medical images as the regions of interest.

[3]

The resultant image 206 is generated by superimposing a plurality of medical images. Therefore, it is possible to perform analysis such as the comparison between a plurality of medical images.

[4]

Regions are extracted from the medical images on the basis of the result of machine learning. Therefore, it is possible to extract regions with high accuracy. In addition, machine learning is performed on the basis of the extraction result of each region. Therefore, it is possible to extract regions with high accuracy.

[5]

The landmark candidate regions which are the candidates of the landmark region are preset. The landmark region is selected from the regions extracted from a plurality of medical images among the landmark candidate regions. Therefore, it is possible to set the landmark candidate regions corresponding to a plurality of medical images. In addition, it is possible to select the landmark region from the landmark candidate regions.

[6]

Registration is performed using a plurality of landmark regions such that an error is minimized. Therefore, it is possible to register a plurality of medical images with high accuracy.

[7]

The medical images of the same examination part of the same patient which have been generated at different times are applied as a plurality of medical images. Therefore, it is possible to perform analysis such as the observation of a change in the same examination part of the same patient over time.

[8]

The registration unit 58 transmits the resultant image signal indicating the resultant image 206 to the display control unit 44. Therefore, it is possible to display the resultant image 206 with the display device 24. The image processing unit 42 comprises the display selection unit 59 that selects whether to display the entire resultant image 206 or to display only the region of interest. Therefore, it is possible to select whether to display the entire resultant image 206 or to display only the region of interest.

### Image Processing Apparatus and Method According to Second Embodiment

Next, an image processing apparatus and method according to a second embodiment will be described.

Example of Configuration of Image Processing Apparatus

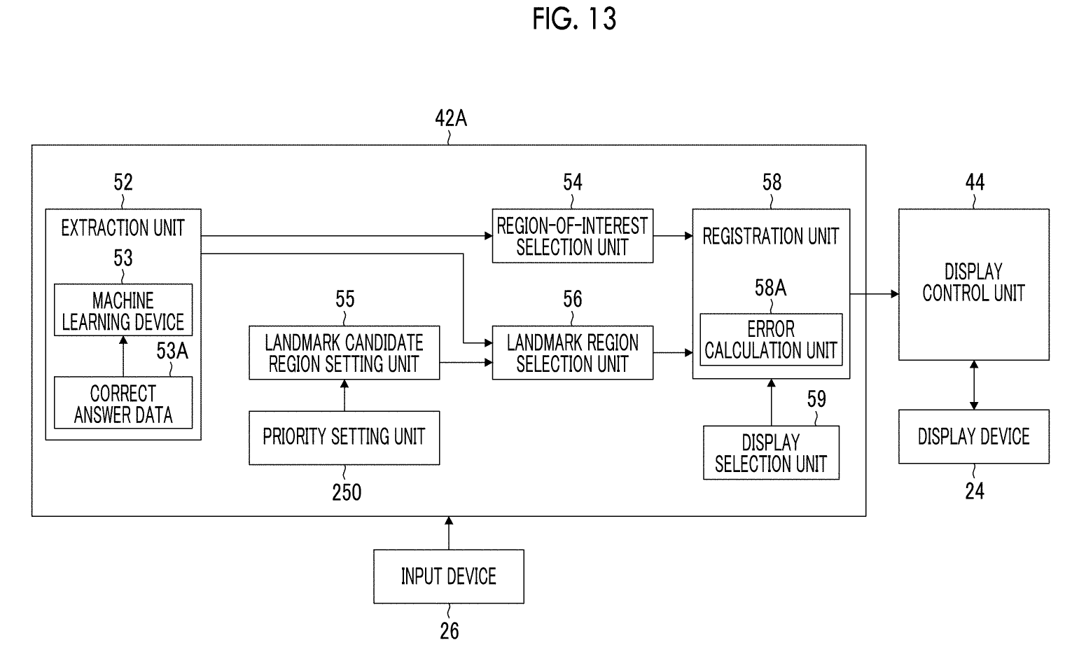

FIG. 13 is a block diagram illustrating the functions of an image processing unit according to a second embodiment. An image processing apparatus according to the second embodiment comprises an image processing unit 42A illustrated in FIG. 13. The image processing unit 42A comprises a priority setting unit 250.

The priority setting unit 250 sets the priority of a landmark candidate region. A landmark region selection unit 56 selects a landmark region on the basis of the priority set to the landmark candidate region.

In the past chest X-ray image 100 and the current chest X-ray image 102 illustrated in FIG. 6, the clavicle, the thorax, the hipbone, the backbone, and the lung field are set as the landmark candidate regions. As an example of the setting of the priorities of the landmark candidate regions, the highest priority is set to the clavicle, the lowest priority is set to the lung field, and the clavicle has the highest priority, followed by the thorax, the hipbone, the backbone, and the lung field in this order.

In the past chest X-ray image 100 and the current chest X-ray image 102 illustrated in FIG. 6, the landmark candidate regions other than the hipbone are extracted. Among the landmark candidate regions extracted from the past chest X-ray image 100 and the current chest X-ray image 102, the clavicle and the thorax having a high priority are selected as the landmark regions.

In the head CT images illustrated in FIGS. 9 to 11, the skull, the eyeball, the cheekbone, the cervical vertebrae, and a cerebral cistern region are set as the landmark candidate regions. As an example of the setting of the priorities of the landmark candidate regions, the highest priority is set to the skull, the lowest priority is set to the cerebral cistern region, and the skull has the highest priority, followed by the eyeball, the cheekbone, the cervical vertebrae, and the cerebral cistern region in this order.

In the example illustrated in FIG. 10, the skull having the highest priority and the eyeball having the second highest priority are selected as the landmark regions. A relatively high priority is set to a landmark candidate region with a relatively small change. In contrast, a relatively low priority is set to a landmark candidate region with a relatively large change.

The priority setting unit 250 illustrated in FIG. 13 can set the priorities of a plurality of landmark candidate regions on the basis of a signal indicating priority setting information input through the input device 26.

FIG. 14 is a diagram illustrating an example of the configuration of a priority setting screen. A first setting tab 262 for designating a region with the highest priority, a second setting tab 264 for designating a region with the second highest priority, a third setting tab 266 for designating a region with the third highest priority, a fourth setting tab 268 for designating a region with the fourth highest priority, and a fifth setting tab 270 for designating a region with the lowest priority are displayed on a priority setting screen 260 illustrated in FIG. 14.

Character input or a pull-down menu may be applied to the first setting tab 262. This holds for the second setting tab 264, the third setting tab 266, the fourth setting tab 268, and the fifth setting tab 270.

The operator inputs region names to the first to fifth setting tabs 262 to 270 and presses an OK button 272 to confirm the setting of the priority. In addition, no information may be input to the second to fifth setting tabs 264 to 270.

FIG. 14 illustrates the priority setting screen 260 comprising five priority setting tabs. However, the number of priority setting tabs may change appropriately depending on, for example, the type of medical image and the region of interest.

### Procedure of Image Processing Method According to Second Embodiment

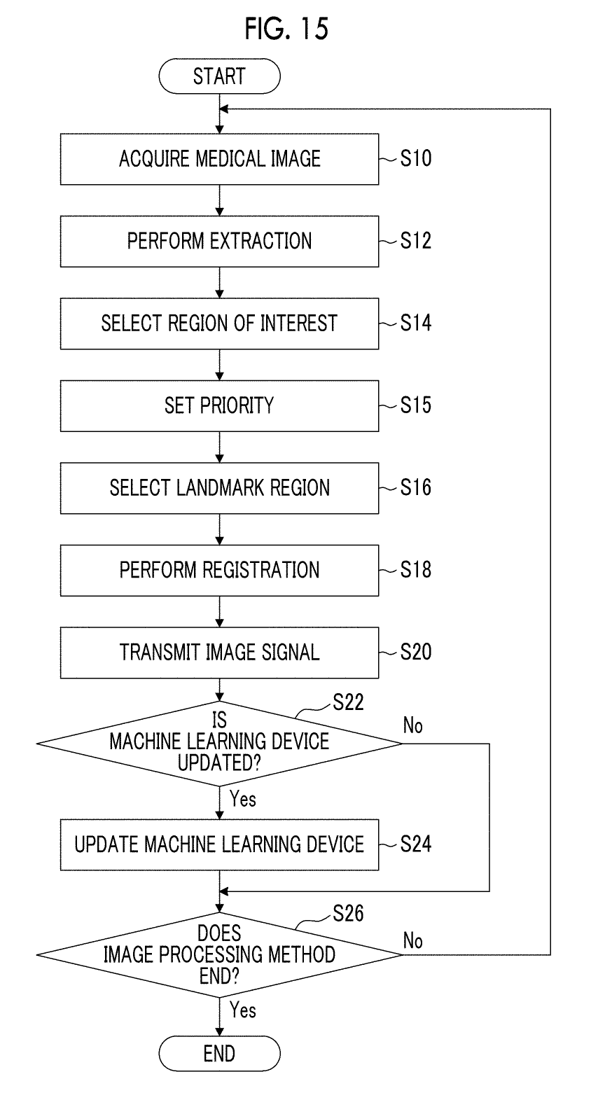

FIG. 15 is a flowchart illustrating the flow of the procedure of the image processing method according to the second embodiment. The flowchart illustrated in FIG. 15 differs from the flowchart illustrated in FIG. 5 in that a priority setting step S15 is added between the region-of-interest selection step S14 and the landmark region selection step S16.

In the priority setting step S15, the priority setting unit 250 illustrated in FIG. 13 sets the priorities of preset landmark candidate regions. After the priority setting step S15, the process proceeds to the landmark region selection step S16.

In the landmark region selection step S16, the landmark region selection unit 56 illustrated in FIG. 13 selects the landmark regions in descending order of the priorities set to the landmark candidate regions in the priority setting step S15. Since the other steps are the same as those illustrated in FIG. 5, the description thereof will not be repeated here.

Operation and Effect of Image Processing Apparatus and Method According to Second Embodiment

The image processing apparatus and method according to the second embodiment can have the following operation and effect.

[1]

The priority setting unit 250 that sets the priority of the landmark candidate region is provided. Therefore, it is possible to select a landmark region on the basis of priority.

[2]

The priority setting screen 260 is displayed on the display device 24. A setting tab that enables the operator to input region information with the input device is displayed on the priority setting screen 260. Therefore, it is possible to set the priority of the landmark candidate region with the input device.

Example of Application to Network System

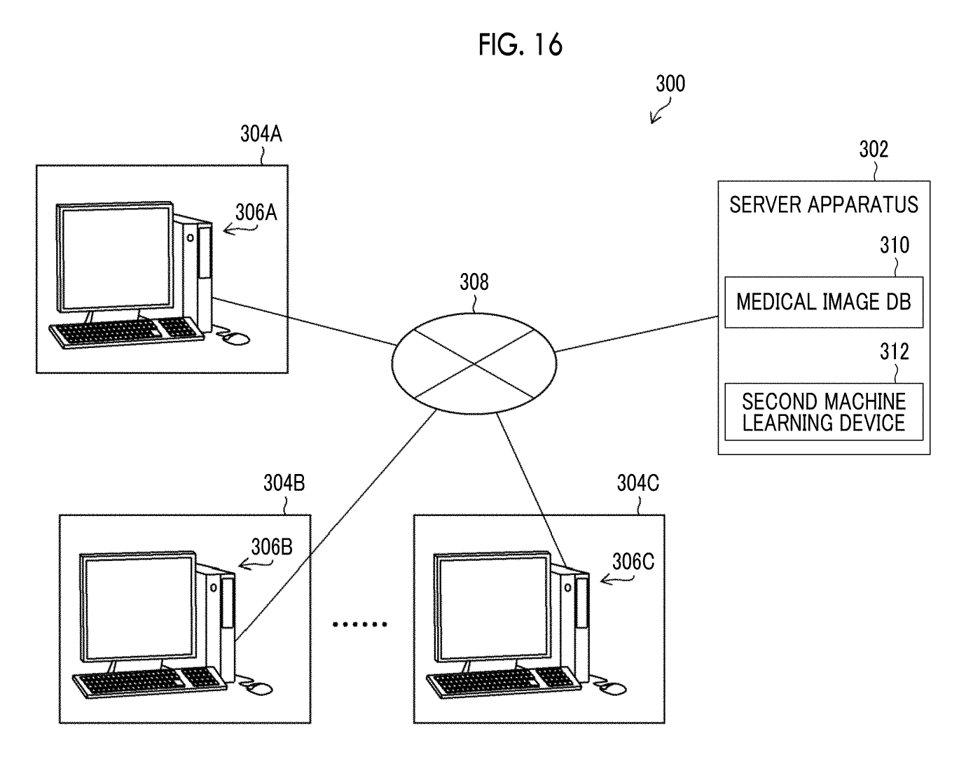

FIG. 16 is a block diagram illustrating an example of the configuration of an information processing system to which a network system is applied. An information processing system 300 illustrated in FIG. 16 comprises a server apparatus 302 and a terminal apparatus 306 provided in a medical institution 304. The server apparatus 302 and the terminal apparatus 306 are connected through a network 308 so as to communicate with each other.

The medical institution 304 is a general term of a first medical institution 304A, a second medical institution 304B, and a third medical institution 304C illustrated in FIG. 16. In addition, the terminal apparatus 306 is a general term of a terminal apparatus 306A provided in the first medical institution 304A, a terminal apparatus 306B provided in the second medical institution 304B, and a terminal apparatus 306C provided in the third medical institution 304C illustrated in FIG. 16.

The terminal apparatus 306 has the same configuration and function as the image processing apparatus 12 described with reference to FIGS. 1 to 4. Here, for example, the description of the configuration and function of the terminal apparatus 306 will not be repeated. The terminal apparatus 306 is connected to the modality provided in the medical institution 304 so as to communicate with the modality. In FIG. 16, the modality is not illustrated. The modality is denoted by reference numeral 14 in FIG. 1.

The server apparatus 302 comprises a medical image database 310 such as the image database 16 illustrated in FIG. 1. The server apparatus 302 is configured such that it can transmit and receive the medical images to and from the terminal apparatus 306 at a high speed. DB illustrated in FIG. 16 is an abbreviation of database.

A network attached storage (NAS) connected to the network 308 can be applied as the medical image database 310. A disk device connected to a storage area network (SAN) can be applied as the medical image database 310.

The server apparatus 302 comprises a second machine learning device 312. A convolutional neural network can be applied as the second machine learning device 312, similarly to the machine learning device 53 illustrated in FIG. 4.

The second machine learning device 312 can have the functions of the machine learning device 53 illustrated in FIGS. 4 and 13. The second machine learning device 312 provided in the server apparatus 302 can function as a machine learning device update unit that updates the machine learning device 53.

That is, the second machine learning device 312 may perform machine learning using the extraction result of the extraction unit 52 illustrated in FIGS. 4 and 13 to update the extraction rule applied to the extraction unit 52 and to update the machine learning device 53.

A public line network or a leased line network may be applied as the network 308. A high-speed communication cable, such as an optical fiber, is applied to the network 308. A communication protocol based on the DICOM standard can be applied to the network 308.

Example of Application to Program Causing Computer to Function as Image Processing Apparatus

The above-mentioned image processing method can be configured as a program that causes a computer to implement functions corresponding to each unit of the image processing apparatus and functions corresponding to each step of the image processing method.

For example, a program can be configured which causes a computer to implement the following functions: an image acquisition function of acquiring a first medical image and a second medical image; an extraction function of extracting a plurality of regions including a region of interest from each of the first medical image and the second medical image; a landmark region selection function of selecting a specific region which is a region common to the first medical image and the second medical image and is different from the region of interest among a plurality of regions of the first medical image and a plurality of regions of the second medical image as a landmark region that is a standard for registering the first medical image and the second medical image; and a registration function of registering the first medical image and the second medical image using the landmark region as the registration standard to generate a resultant image in which the first medical image and the second medical image are superimposed.

The program causing the computer to implement the image processing functions can be stored in an information storage medium which can be read by the computer and is a non-transitory tangible information storage medium and can be provided through the information storage medium.

In addition, instead of the aspect in which the program is stored in the non-transitory information storage medium and is then provided, a program signal may be provided through the network.

### For Combinations of Embodiments and Modification Examples

The components described in the above-mentioned embodiments and the components described in the modification examples can be appropriately combined with each other. In addition, some of the components may be replaced.

In the above-described embodiments of the invention, components can be appropriately changed, added, and removed without departing from the scope and spirit of the invention. The invention is not limited to the above-described embodiments and can be changed and modified in various ways by those skilled in the art without departing from the technical idea of the invention.

### EXPLANATION OF REFERENCES

10: medical information system
12: image processing apparatus
14: modality
16: image database
18: network
20: mouse
22: keyboard
24: display device
26: input device
30: control unit
32: memory
34: hard disk drive
36: communication interface
38: input controller
39: display controller
40: overall control unit
41: image acquisition unit
42: image processing unit
42A: image processing unit
43: deep learning algorithm
44: display control unit
45: screen generation unit
46: input control unit
47: storage unit
48: image storage unit
49: program storage unit
50: first medical image
51: second medical image
52: extraction unit
53: machine learning device
53A: correct answer data
54: region-of-interest selection unit
55: landmark candidate region setting unit
56: landmark region selection unit
58: registration unit
58A: error calculation unit
59: display selection unit
60: communication signal line
100: past chest X-ray image
102: current chest X-ray image
104: resultant image
104A: resultant image
110: clavicle
112: thorax
114: heart
120: clavicle
122: thorax
124: heart
140: display selection screen
142: first selection button
144: second selection button
146: OK button
200: first past head CT image
200A: first past head CT image
200B: first past head CT image
202: second past head CT image
202A: second past head CT image
202B: second past head CT image
204: current head CT image
204A: current head CT image
204B: current head CT image
206: resultant image
206A: resultant image
206B: resultant image
210: brain
212: skull
214: eyeball
216: cheekbone
220: brain
222: skull
224: eyeball
226: cheekbone
230: brain
232: skull
234: eyeball
236: cheekbone
240: processing target image selection screen
242: OK button
250: priority setting unit
260: priority setting screen
262: first setting tab
264: second setting tab
266: third setting tab
268: fourth setting tab
270: fifth setting tab
272: OK button
300: information processing system
302: server apparatus
304: medical institution
304A: first medical institution
304B: second medical institution
304C: third medical institution
306: terminal apparatus
306A: terminal apparatus
306B: terminal apparatus
306C: terminal apparatus
308: network
310: medical image database
312: second machine learning device
S10 to S26: each step of image processing method

What is claimed is:

1. An image processing apparatus comprising:
an image acquisition unit that acquires a plurality of medical images including a first medical image and a second medical image each of which includes a region of interest to be compared;
an extraction unit that extracts a plurality of regions including the region of interest from each of the first medical image and the second medical image;
a landmark region selection unit that selects a specific region which is common to the first medical image and the second medical image and is different from the region of interest among the plurality of regions of the first medical image and the plurality of regions of the second medical image as a landmark region which is a standard for registering the first medical image and the second medical image; and
a registration unit that performs rigid registration or linear registration for the first medical image and the second medical image, using the landmark region as the registration standard, to generate a resultant image in which the first medical image and the second medical image have been superimposed.

2. The image processing apparatus according to claim 1, further comprising:
a region-of-interest selection unit that selects one or more regions of interest from the plurality of regions of the first medical image and the plurality of regions of the second medical image.

3. The image processing apparatus according to claim 2,
wherein the registration unit generates a resultant image in which the regions of interest selected by the region-of-interest selection unit have been superimposed.

4. The image processing apparatus according to claim 1,
wherein the extraction unit extracts the regions on the basis of a result of learning using a set of the medical images and an extraction result of the regions or a set of the medical images and a selection result of the landmark region as correct answer data.

5. The image processing apparatus according to claim 1,
wherein the extraction unit extracts the regions on the basis of a result of learning for each region using a set of the medical images and an extraction result of each of the regions or a set of the medical images and a selection result of the landmark region as correct answer data.

6. The image processing apparatus according to claim 1, further comprising:
a landmark candidate region setting unit that sets landmark candidate regions, which are candidates of the landmark region, in the first medical image and the second medical image.

7. The image processing apparatus according to claim 6,
wherein the landmark candidate region setting unit sets all of regions which are capable of becoming the landmark region among the regions forming at least one of the first medical image or the second medical image as the landmark candidate regions.

8. The image processing apparatus according to claim 6,
wherein the landmark region selection unit selects the landmark region from the regions extracted from the first medical image and the second medical image among the landmark candidate regions.

9. The image processing apparatus according to claim 6, further comprising:
a priority setting unit that sets priorities to the landmark candidate regions.

10. The image processing apparatus according to claim 9,
wherein, in a case in which two or more landmark candidate regions are set, the landmark region selection unit selects one or more landmark regions in descending order of the priorities of the landmark candidate regions.

11. The image processing apparatus according to claim 1,
wherein the landmark region selection unit selects a plurality of the landmark regions, and
in a case in which the resultant image is generated using the plurality of landmark regions selected by the landmark region selection unit, the registration unit registers the first medical image and the second medical image such that an error between the landmark regions is minimized.

12. The image processing apparatus according to claim 1,
wherein the image acquisition unit acquires the first medical image and the second medical image generated by the same type of modality.

13. The image processing apparatus according to claim 1,
wherein medical images of the same examination part of the same patient which have been generated at different times are applied as the first medical image and the second medical image.

14. The image processing apparatus according to claim 1, further comprising:
an image signal transmission unit that transmits a resultant image signal indicating the resultant image to a display device.

15. The image processing apparatus according to claim 14, further comprising:
a display selection unit that selects whether to display the entire resultant image on the display device or to display only the region of interest of the resultant image on the display device.

16. An image processing method comprising:
an image acquisition step of acquiring a plurality of medical images including a first medical image and a second medical image each of which includes a region of interest to be compared;
an extraction step of extracting a plurality of regions including the region of interest from each of the first medical image and the second medical image;
a landmark region selection step of selecting a specific region which is common to the first medical image and the second medical image and is different from the region of interest among the plurality of regions of the first medical image and the plurality of regions of the second medical image as a landmark region which is a standard for registering the first medical image and the second medical image; and
a registration step of performing rigid registration or linear registration for the first medical image and the second medical image, using the landmark region as the registration standard, to generate a resultant image in which the first medical image and the second medical image have been superimposed.

17. A non-transitory computer-readable tangible medium storing a program that causes a computer to implement:
an image acquisition function of acquiring a plurality of medical images including a first medical image and a second medical image each of which includes a region of interest to be compared;
an extraction function of extracting a plurality of regions including the region of interest from each of the first medical image and the second medical image;
a landmark region selection function of selecting a specific region which is common to the first medical image and the second medical image and is different from the region of interest among the plurality of regions of the first medical image and the plurality of regions of the second medical image as a landmark region which is a standard for registering the first medical image and the second medical image; and
a registration function of performing rigid registration or linear registration for the first medical image and the second medical image, using the landmark region as the registration standard, to generate a resultant image in which the first medical image and the second medical image have been superimposed.
